(19) United States
(12) Patent Application Publication
(10) Pub. No.: US 2025/0042496 A1
(43) Pub. Date: Feb. 6, 2025

(54) BICYCLE, AND WHEEL COMPONENT FOR A BICYCLE

(71) Applicant: DT SWISS INC., Grand Junction, CO (US)

(72) Inventors: Simon HUGENTOBLER, Liebefeld (CH); Andreas TSCHANZ, Legnau (CH); Nils VERHOEVEN, Biel (CH)

(21) Appl. No.: 18/789,234

(22) Filed: Jul. 30, 2024

(30) Foreign Application Priority Data
Aug. 1, 2023 (DE) 102023120454.8

(51) Int. Cl. B62J 45/423; B62J 45/412

(52) U.S. Cl. CPC B62J 45/423; B62J 45/412

(57) ABSTRACT

A bicycle wheel component with a rim for a tire, and a magnetic device with a housing and a magnet, wherein the rim includes a rim body with a circumferential rim well and lateral rim flanks, which form rim flanges at the radially outwardly ends. The rim body includes a valve hole in a radially outwardly rim well area. A tire cavity is defined between the rim well and a tire tread of a tire mounted on the rim body. The housing of the magnetic device is connected with the rim body secure against loss, by an adhesive layer between the rim well and the housing of the magnetic device. In the region of the valve hole, the housing of the magnetic device has a through opening for the valve, through which the valve protrudes, and fastens the magnetic device radially outwardly on the rim well of the rim body.

### BACKGROUND

The present invention relates to a wheel component for a bicycle, and a bicycle comprising at least two wheels and a pedal drive which is at least partially muscle-powered in regular operation, wherein at least one of the wheels is configured as a front wheel and at least one of the wheels, as a rear wheel. The wheels each comprise a hub, a rim connected with the hub with a rim body, each having a tire mounted on the rim body. The bicycle captures, by means of at least one sensor, a measure of the traveling speed.

In the prior art, a great variety of bicycles have been disclosed, equipped with a speedometer, so as to provide the rider during riding with illustrative information and data on the traveling speed and optionally the distance travelled. Electronic systems may display the current traveling speed, the distance travelled since starting, the average speed, and the total distance travelled. Moreover, electronic systems may have additional sensors to display the pedaling frequency in the bottom bracket, and optionally a chest belt to display the user's heart rate.

For some decades now, these systems tend to operate by way of a magnetic pulse generator, wherein the magnet is mounted to a spoke, outputting magnetic pulses as the wheel rotates, which pulses are detected respectively generated, for example by a magnetic sensor mounted on the fork, as the magnet rotates past. The known wheel circumference and the obtained frequency of the captured magnetic pulses allow derivation of the traveling speed and the distance travelled. These systems have been known for a number of decades, and they are basically functional. It is a drawback that the magnet fastened to a spoke may slip or twist or fall off, so as to impede the reliability of, or entirely prohibit, capturing the travelling parameters. Mechanical counters have been used in the past, which has other drawbacks.

Further, in recent years, bicycles have become known and popular, using an electric motor for controlled assistance to the user in pedaling. This does not only relate to city bikes, but also to mountain bikes and racing bicycles. These bicycles require capturing the traveling speed, for controlling the motor assistance. These systems likewise tend to provide for a magnet mounted on a spoke, which outputs pulses to, or generates pulses in, a sensor as the wheel rotates. The signals are evaluated for determining the traveling speed and the distance travelled.

In the case of electrically assisted bicycles, Robert Bosch GmbH e.g. provides electric motors, which are employed as mid-mounted motors, electrically assisting the rider directly in the pedal crank.

EP 4 137 394 A1 has disclosed a rim magnet arrangement for bicycles with mid-mounted motors, wherein the rim magnet is radially pushed onto the valve from the inside and urged against the rim base. The rim magnet is fastened and secured with a valve nut and is resiliently urged against the rim base. The sensor for capturing the magnetic field is accommodated in the mid-mounted motor, and captures the magnetic field of the magnet as the valve rotates past the bottom bracket or the mid-mounted motor. The system operates generally satisfactorily. There is, however, the drawback that when exchanging the valve or the tube, the rim magnet must not be overlooked in the following re-installation, or it may even be lost. Also it may happen that during transporting or when parking a bicycle, the rim magnet may hit against other components or parts, and may be destroyed or lost. Also, when inflating the tire the valve nut may be intentionally or inadvertently loosened, which may result in loss of the rim magnet.

These drawbacks are eliminated in a magnet which is directly fastened to the spoke, which also tends to be light-weight. Basically, a spoke magnet may be bumped or knocked in transport and thus may be e.g. rotated. Then, however, the spoke magnet can readily and quickly be returned to its correct position. This does not require any tool nor a workshop. Also, during tire- or tube changes, the spoke magnet is as a rule never touched nor removed. A lightweight spoke magnet, however, requires a sensor placed close to the magnet for capturing signals. This tends to be realized in mountain bikes.

Alternately, the magnet may be accommodated on a disk brake fastener instead of on the spoke. Again, the signal must be transmitted. To this end, a suitable cable must be guided along the frame toward the sensor disposed near the magnet. The cable in turn may be destroyed as well.

EP 3 435 024 A1 has disclosed a method and an apparatus for monitoring movement of a wheel of a two-wheeled vehicle. A magnet, or better a number of magnets, is/are fastened to the wheel, evenly distributed. A magnetic field sensor assigned to the frame captures the magnetic field of the magnets in two spatial directions. The magnetic field signals captured from a faultless wheel are stored, and what is the current magnetic field signal is compared against the stored values. In the case of significant deviations, a wheel defect is signaled. Several magnets enable to detect a side run-out or wobble, radial run-out, or a defectively mounted wheel. It is a drawback that for detecting e.g. a wobble or a side run-out, a number of magnets must be used, distributed over the circumference. The magnets may be attached to the tire cover, in or on the rim, or to the spoke exterior, or in or on the tire valve. A number of magnets in the tire cover or in the rim require specific tires or specifically manufactured rims. This is complex, and expensive, since these tires and rims are not generally used.

Bicycle computers provided with a GPS module have also been disclosed, which derive the traveling speed and the distances travelled from the GPS signals. This is basically functional, and over extended distances results in sufficient accuracy in capturing and detecting the distance travelled. It is a drawback though that the riding parameters cannot be determined at all times precisely, respectively sufficiently precisely, e.g. for motor control or otherwise, for example while the rider travels through a dense forest or a tunnel.

It is therefore the object of the present invention to provide a bicycle and a wheel component which results in a still more reliable determination of the travelling parameters.

### SUMMARY

A wheel component according to the invention is provided for at least partially muscle-powered vehicles and, in particular, bicycles, and comprises a rim for receiving a tire equipped with a tire tread. Furthermore, the wheel component comprises a magnetic device. The rim comprises a rim body with lateral rim flanks, which preferably form rim flanges at the radially outwardly end thereof. The rim body, in particular, comprises (axially between the rim flanges) a valve hole on a radially outwardly rim well area (in particular, radially outwardly on the rim well). The rim body, in particular, comprises a radially inwardly rim base area, which may be absent in the case of disk wheels. The magnetic device comprises a housing with at least one magnet (accommodated thereon or therein). A tire cavity is, respectively can be, in particular, defined between the rim well and the tire tread of a tire provided to be accommodated on the rim body. Such a tire cavity forms a boundary of the rim well and the tires, and optionally the rim flanges. The housing of the magnetic device is preferably attached radially outwardly on the rim well of the rim body. This means, in particular, that the magnetic device is thus attached inside of the tire cavity. Particularly preferably, the housing of the magnetic device is connected with the rim body, secure against loss, by an adhesive layer between the rim well and the housing of the magnetic device. Preferably, the housing of the magnetic device has a through opening for the valve in the region of the valve hole, through which the valve protrudes, fastening, and, in particular, additionally securing, the magnetic device radially outwardly on the rim well of the rim body (and thus inside of the tire cavity).

The wheel component according to the invention has many advantages. The magnetic device is fastened to the rim well radially outwardly, but not radially inwardly to the rim base or to a spoke, as in the prior art. This offers the quite considerable advantage that in use as intended, the magnetic device is accommodated in the tire cavity, and already for this reason, it can as a rule be neither damaged nor lost when the bicycle or a wheel is parked. Also, there is no risk of loss when changing tires.

Although a mounted tire is not required for realizing the invention, visualizing a mounted tire facilitates visualization of placement of the parts. Then the magnetic device is located inside of the volume opened up by the tires and the rim well.

The housing, in particular, has a length, a width transverse thereto, and a height transverse to the length and width. The length is, in particular, at least twice the width and the height. The magnetic device, in particular, has a length at least three times the width or height. The maximal (radial) height is preferably less than a third or a quarter of the length. The housing of the magnetic device is fastened in the rim well area in the region of the valve hole. Preferably, the housing of the magnetic device extends across the entire valve hole. The bottom surface of the housing is adapted to the rim well area over (at least) a substantial part of the length of the housing. Thus, it is possible for the bottom structure of the magnetic device to (substantially) bear against the rim well area.

An (air-filled) tire may be mounted on the rim body. A tube may be received in the tire. The system may be configured as a “tubeless” system not comprising a tube.

The magnetic device generates (magnetic) pulses in a sensor as the wheel rotates.

It is another considerable advantage of the wheel component according to the invention that the magnetic device is securely accommodated on the rim body inside of a volume defined by the rim body and the tire. Thus, the magnetic device is accommodated secure against loss, and even during transport or storing or parking the bicycle it cannot be damaged or destroyed or displaced, or for example not even rotated. This enables increased operational reliability. Moreover, tube exchanges do not carry the risk of overlooking to mount the magnetic device, or even to inadvertently discard it together with a defective tube.

Another, not inconsiderable advantage consists in the fact that, in particular, in the case of use with an electro-assisted bicycle and for example a mid-mounted motor with an attached or integrated sensor, the radial distance of the magnetic device from the sensor in the region of the bottom bracket or of the pedal drive, might be considerably narrower than when attaching the magnetic device to a spoke or to the air valve outside of the rim. The fact that the magnetic device is attached radially outwardly on the rim well, causes in many cases a quite considerably decreased radial distance of the magnetic device from a sensor provided on the mid-mounted motor.

Another problem in the prior art is, that visibly mounted magnets may be damaged due to vandalism. Here, the invention provides for another advantage. A sensor, in particular, in an electric motor reduces the overhead, since a cable to the sensor is (virtually) absent. Then, a cable to the sensor guided along the frame is not necessary. The invention reduces the distance from the sensor (e.g. in the motor), so that the required magnetic field can be reduced. Weight and overhead may be saved.

The distance between the sensor and the magnetic device may be reduced to less than half, specifically in sports bicycles with high rims in aerodynamic configurations. This allows provision of the magnetic devices with smaller and lighter configurations. The magnetic field strength of the magnetic device may be chosen lower, since the distance given is shorter. Also, the weight can thus be reduced. Also, mass imbalance due to the magnetic device is reduced.

Another advantage of the configuration according to the invention is that, due to the protected accommodation in the volume of the tire and of the rim body, the magnetic device is better protected against environmental influences, so that any encapsulation can be provided to be simpler than if the magnetic device is for example attached to a spoke.

The housing of the magnetic device has a through opening with which to secure the magnetic device on the rim body, by means of a safety device, radially outwardly on the rim well. The safety device can be provided by any component. Particularly preferably, the valve serves as a safety device, passing through the through opening, and securing the magnetic device radially outwardly on the rim body.

In preferred specific embodiments, the housing of the magnetic device is retained on the rim body secure against loss, by an adhesive layer between the rim well and the housing of the magnetic device.

Preferably, the adhesive layer is disposed (directly) between the housing of the magnetic device and the rim well. This means that the adhesive layer contacts the housing and the rim well.

Preferably, a circumferential rim tape is disposed (and, in particular, glued on) between the housing of the magnetic device and the rim well. In particular, the, or at least one of the, adhesive layer(s) is disposed (directly) between the housing of the magnetic device and the rim tape. This means that the adhesive layer contacts the housing and the rim tape.

In a preferred specific embodiment, the lateral rim flanks form a rim base in a radially inwardly region.

Particularly preferably, so-called hollow rims are employed. The hollow space is enclosed radially inwardly by the rim base and radially outwardly, by a rim well (in particular, connecting the two rim flanks). The rim well area is configured respectively provided radially outwardly on the rim well.

The hollow space is enclosed radially inwardly by the rim base and radially outwardly, by a rim well connecting the two rim flanks. The tire cavity is then enclosed radially outwardly by the tire and radially inwardly, by the rim well.

The term “enclosed” herein does not mean that the hollow space or the tire cavity must be “tight” (and, in particular, not airtight). Intended is a definition of an enclosed space. In the tire cavity, e.g. a tube may be accommodated, which is then subjected to the desired pressure.

Preferably, the bottom surface of the housing of the magnetic device is configured curved in the peripheral direction of the rim. This preferably allows the magnetic device to bear against the rim well over a considerable part of the length (in the peripheral direction).

Preferably, the bottom surface of the housing of the magnetic device is adapted to the cross sectional profile of the rim well area. Then, the magnetic device can bear against the rim well (also) over the width, or a substantial part of the width (in the axial direction).

In preferred configurations, the hollow space is sealed. Sealing can preferably be done by means of a (separate) rim tape covering and, in particular, sealing the spoke holes in the rim well. If the rim tape in a “tubeless system” is replaced on a regular basis (e.g. once a year), the magnetic device will also be removed and then re-mounted on a regular basis.

A peripheral rim well trough is, in particular, configured (in an axially central region) on the rim well. The rim well trough has the shape of a rounded groove. The rim well trough can also be referred to as a rim well recess. Preferably, the rim well trough accommodates (part of) the magnetic device. Preferably, the magnetic device does not protrude laterally from the rim well trough.

Optionally, the spoke nipples are accessible through the rim well trough. Optionally, after removing the rim tape.

Preferably, the lateral distance of the rim flange from the magnetic device is larger than the (minimal or maximal) wall thickness of the axial rim flange. This enables secure operation and simple installation.

The magnetic device is fastened to the rim well. The magnetic device may for example be riveted, screwed, welded, and/or glued to the rim well. In simple cases, the magnetic device may be riveted to a hole provided in the rim well. In all the configurations, an additional adhesive layer may be provided on the housing of the magnetic device. Particularly preferably, the magnetic device is glued onto the rim well and/or onto a rim tape glued onto the rim body.

An exchangeable attachment of the magnetic device for example to the rim well has the advantage that the magnetic device can be exchanged if required. In the tire cavity the magnetic device is accommodated in the rim well highly protected, and it is not exposed to normal ambience conditions. Nor is there the risk of damage for example in transporting such a bicycle. In preferred configurations, the magnetic device is glued to the rim well in the region of the valve hole (or another hole). Preferably, the magnetic device has a through opening for the valve. Thus, the magnetic device can be fastened and/or secured. If the magnetic device is (additionally) glued to the rim well with its housing, the magnetic device is retained by the gluing area when the valve and/or the tube is exchanged, so that even in this case, there is no risk of losing the magnetic device.

Fastening by rivets is, in particular, feasible if the wheel is not a “tubeless system”.

Particularly preferably, a rim tape is glued onto the rim well area and accommodated between the magnetic device and the rim body. This facilitates mounting the rim tape, since the magnetic device does not need to be considered.

Preferably, an adhesive tape (in particular, elastic and) preferably with airtight sealing to the sides is fastened to the bottom surface of the housing. The adhesive tape has at least one adhesive layer. The adhesive tape joins the magnetic device to the rim body (indirectly or directly). The adhesive tape is, in particular, (partially) glued onto the rim tape and/or (partially) onto the rim body.

In preferred configurations, the rim well has a bore/aperture for the valve. The magnetic device is preferably additionally secured with a double-sided adhesive tape, so that the magnetic device is not inadvertently lost when the valve is removed. Preferably, the magnetic device is glued onto a rim tape which seals the spoke holes in the rim well. When replacing the rim tape, the magnetic device must be disassembled as well and re-glued onto the new rim tape.

Particularly preferably, the magnetic device is glued outwardly onto a previously applied rim tape. In “tubeless systems”, the valve is radially pushed from the outside through the hole in the magnetic device and through the valve hole. Then, the valve nut secures both the valve and the magnetic device.

Preferably, a valve seating is configured on the magnetic device, against which a sealing ring of the valve bears airtight (and pressure-tight for operating pressures). Preferably, the rim tape and the (radial) bottom face of the magnetic device provide airtight sealing of the rim well and the valve hole.

It is also conceivable to accommodate the magnetic device between the rim well and a (circumferential) rim tape. For example, the magnetic device can be glued (only) to the rim well. Then, the magnetic device is additionally secured by the circumferential rim tape, even if the magnetic device is not retained by a screw, rivet, or the valve. A certain drawback is the increased mounting work for the rim tape, which must also have appropriate bulges for the magnetic device.

It is also conceivable for two or more magnetic devices to be distributed (substantially symmetrically) over the circumference of the rim. Then, a corresponding multitude of pulses during a revolution is emitted, which a sensor can capture, corresponding to the quantity of the magnetic devices (and the magnets contained therein).

In e-bike motors, a plurality of measurement data may be utilized for controlling, e.g. the rotational force or the (current) gradient, speeds also via GPS, the pedaling frequency and/or performance, etc. The pertaining sensors can be positioned very precisely in assemblies. Optionally, individual signals may be utilized for verification.

Preferably, the rim flanks extend from the rim base radially outwardly beyond the rim well, forming rim flanges accommodating the tire. For rims having these rim flanges extending radially outwardly beyond the rim well, it is preferred for the magnetic device to not extend radially beyond the rim flanges. Then, even in case of a defective tire and/or tube, the magnetic device is reliably protected even when (briefly) continuing further with a flat tire.

Preferably, the radially outwardly end regions of the rim flanges form axially inwardly protruding, circumferential beads, against which tire beads bear axially inwardly. Thus, the tire is securely and reliably received on the rim.

Preferably, the magnetic device is axially accommodated and disposed between the circumferential beads and/or the tire beads. Thus, the magnetic device does not interfere with installation nor demounting, nor operation, permitting reliable, low-maintenance operation.

Particularly preferably, the magnetic device is radially accommodated between the rim well and the radially outwardly end regions of the rim flanges, and axially between and spaced apart from (each of) the rim flanges. Preferably, the radial distance of the radially most outwardly spot of the magnetic device from the radially outwardly end regions of the rim flanges is at least 3 mm and, in particular, at least 0.5 mm or 0.25 mm. This considerably facilitates installation, operation and maintenance.

The axial distance of the magnetic device from the two beads is, in particular, larger than the thinnest wall thickness of the rim flanges. Preferably, the axial distances of the magnetic device from the two beads are larger than the axial wall thicknesses of the rim flanges in the region of the beads. This secures reliable installation of the tire.

In advantageous configurations, spoke holes are configured in the rim body (and, in particular, the rim base), through which the spokes are passed, subject to tensile stress, and supported on the central hub and on the rim body (and, in particular, the rim base).

It is also conceivable for the magnetic device to be accommodated or fastened secure against loss for example on a (special or standard) spoke nipple inside of the rim body.

The housing of the magnetic device, in particular, has a length, a width transverse thereto, and a height transverse to the length and width. The length of the housing is, in particular, at least twice the width and the height. The housing of the magnetic device can, in particular, be fastened in the region of the valve hole in the rim well area of a (standard) rim. The bottom surface of the housing of the magnetic device is adapted to the peripheral surface of the rim well area (of a standardized rim) over a substantial part of the length of the housing.

The rim is, in particular, configured so as to comply with the ETRTO (“European Tyre and Rim Technical Organization”) standard. Thus, data are available for an appropriate configuration of the bottom surface of the magnetic device. It is thus possible to (substantially) enable (complete) bearing against the rim well area.

In all the configurations of wheel components it is preferred for the magnetic device to comprise at least one mounting hole for receiving a valve, and, in particular, a seating for sealing the valve in the mounting hole.

In advantageous specific embodiments of a wheel component, the seating accommodates (at least) one sealant.

In all the configurations it is preferred for the magnetic device to have a height of less than 8 mm and/or a width of less than 20 mm and/or a length of less than 80 mm.

A bicycle according to the invention comprises at least two wheels and an at least partially muscle-powered pedal drive, wherein at least one of the wheels is configured as a front wheel and at least one of the wheels, as a rear wheel. At least one of the wheels, in particular, comprises a wheel component as described above. The wheels each comprise a hub and a rim connected with the hub, with a rim body with lateral rim flanks, which preferably form rim flanges at the radially outwardly ends. The rim body comprises (between the rim flanges) a radially outwardly rim well area and, in particular, a valve hole configured thereon. A tire is mounted on each rim body. At least one of the wheels accommodates a magnetic device, for generating pulses on a sensor as the wheel rotates. The housing of the magnetic device has a length, a width transverse thereto, and a height transverse to the length and width, wherein the length of the housing is, in particular, at least twice the width and the height. Preferably, the housing of the magnetic device is fastened to the rim well area in the region of the valve hole.

The bottom surface of the housing is, in particular, adapted to the rim well area over (at least) a substantial part of the length of the housing. Thus, it is possible for the bottom surface of the housing to substantially bear against the rim well area.

In particularly preferred configurations, the bicycle comprises at least one sensor for obtaining at least one travelling parameter and, in particular, the traveling speed. The sensor, in particular, captures magnetic pulses during the rotary motion of the wheel.

Preferably, at least one sensor is disposed on the frame and, in particular, in the region of the bottom bracket or on the seat tube. It is also conceivable for the sensor to be fastened to other locations of the frame or the bicycle fork.

Particularly preferably, the sensor (or at least one sensor) is incorporated in the electric motor (respectively its housing). It is a big advantage that no cable to a sensor needs to be installed. Such a cable requires installation, it can become defective, and it is optically not appealing.

In preferred configurations, an electric motor is comprised as a pedal drive assist. Particularly preferably, the electric motor is configured as a mid-mounted motor and is accommodated (on the pedal drive) in the longitudinal direction between the front wheel and the rear wheel. In preferred configurations, the electric motor has a sensor for obtaining at least one travelling parameter and, in particular, the traveling speed. The sensor can capture the magnetic pulses of the magnetic device generated by means of the rotation past the sensor as the wheel rotates, to enable travel-related control of the electric motor by means of a control device. Controlling may be related to the travelling situation. Control is possible e.g. as a function of the acceleration and/or speed and in dependence of further travelling parameters.

In preferred configurations, the sensor is accommodated on or in the housing of the electric motor. Particularly preferably, the sensor is incorporated in, or fastened immediately or directly adjacent to, the housing of the mid-mounted motor. The term “fastened directly adjacent” is understood to mean that the distance between the sensor and the housing of the mid-mounted motor is less than the entire or half or a quarter of the diameter of the mid-mounted motor. Integration of the sensor in the mid-mounted motor results in a particularly trouble-free operation.

In all the configurations it is preferred for a rim tape to be mounted on the rim body and, in particular, on the rim well of the rim body. The rim tape preferably seals the volume between the rim body and the tire (tire cavity).

Specifically, the pulse is as a rule only generated when a (permanent) magnet moves past a sensor. The motion is defined by installation of the wheel in the frame. Thus, the wheel rotates around the hub axle and the magnetic device past the magnetic device in a defined track.

The invention offers many advantages and permits a reliable and trouble-free operation.

In a further development of a wheel component, the rim body has an axial width that is less than the radial height of the rim body. Preferably, the axial width of the rim body is less than the radial distance of the rim base from the rim well. This applies, in particular, to aerodynamic wheel components of sports bicycles. Sports bicycles may comprise an electric motor for assisted operation.

In preferred configurations of a wheel component, a rim tape is applied on the rim well of the rim body. Preferably, the magnetic device is glued onto the rim tape on the rim well. This may, in particular, be done by means of a double-sided adhesive tape. Preferably, the housing of the magnetic device is adapted to the shape of the rim well in the peripheral direction and in the axial direction.

In preferred configurations, the magnetic device has at least one mounting hole for receiving (e.g.) a valve. A seating for sealing the valve in the mounting hole is, in particular, comprised. The seating is preferably provided with at least one sealant. The sealant may be, or comprise, e.g. an elastic sealing element. In preferred further developments, the elastic sealing element may be configured in a ring or conical shape. The sealant may be configured as, or comprise, an O ring.

In preferred configurations, the magnetic device has a height of less than 8 mm and/or a width of less than 20 mm and/or a length of less than 80 mm. In the scope of trials and experiments it is conceivable to considerably reduce these dimensions.

When using such a wheel component with a bicycle equipped with a mid-mounted motor with an incorporated sensor, the radial distance between the magnetic device and the sensor may be considerably smaller than provided in the prior art. Therefore it is possible to correspondingly reduce the magnetic field strength (of the magnet or the magnets) of the magnetic device and thus to correspondingly reduce the total weight and the total dimensions of the magnetic device.

Particularly preferably, a magnet of the magnetic device is configured block-shaped and massive. Massive preferably means that the magnet has no hole. For securing or fastening to the rim, an attachment portion (of a lower radial height) can be provided on the housing of the magnetic device. Then, the attachment portion may be configured with a through opening or a mounting hole through which the valve passes, thus securing the entire magnetic device. Adjacent to the attachment portion, the housing preferably comprises a magnet portion in which a magnet is accommodated. The magnet portion is preferably higher than the attachment portion.

It is another advantage of the invention that the magnetic device does not require symmetric accommodation on the valve. Thus, one single, compact magnet may be inserted in the housing of the magnetic device. A division in two parts or a central bore is not required.

Also, the length of the magnetic device is not limited to the circumferential distance between two spokes. Basically, the length may be very large and virtually unlimited. The fact that the magnetic device can be disposed close to the sensor, allowing reduction of the magnetic field strength, while the signal reception has increased reliability. This also allows reduction in the weight, in particular, in the case of hollow rims, whose height exceeds the width (factor 1 or 1.25 or 1.5 or 2). Wherein, the higher the rim, the more advantageous is the invention.

In a more specific configuration of a bicycle according to the invention, it comprises (at least) two wheels, and a muscle-powered pedal drive, and an electric motor for assisting the pedal drive, wherein at least one of the wheels is configured as a front wheel, and at least one of the wheels, as a rear wheel, each comprising a hub and a plurality of spokes. The hub is connected to the rim by way of the spokes. A tire (air-filled) is mounted on the rim. The rim has a rim body with lateral rim flanks, forming a rim base in a radially inwardly region. The electric motor is configured as a mid-mounted motor and is accommodated in the longitudinal direction between the front wheel and the rear wheel. A sensor is assigned to or mounted on, or incorporated in, the electric motor for capturing at least one travelling parameter and, in particular, the traveling speed. At least one of the wheels accommodates, radially outwardly on the rim well, a pulse generator (and, in particular, a magnetic device), to output (magnetic) pulses as the wheel rotates, which the sensor can capture, so as to enable travel-dependent controlling of the electric motor (obtaining for example the acceleration and/or speed) by means of a control device. An advantageous configuration is provided by the fact that the pulse generator (and, in particular, the at least one magnetic device) is glued onto the rim base, respectively glued onto the rim tape on the rim base, and secured by the valve at the valve hole. The pulse generator generates with the rotation, pulses that can be captured by the sensor.

A rim for use or cooperation with the invention, in particular, fulfills at least some of the following conditions:
In all the configurations, the valve hole diameter of the rim 1 is preferably configured according to the ETRTO guidelines for a safe tube seating and is preferably larger than 6 mm.
Furthermore, in all the configurations, the rim flange height is preferably configured according to the ETRTO guidelines for a safe and centric flank guide of the tire and is preferably larger than 5 mm.
The rim flange depth is, in particular, configured according to the ETRTO guidelines regarding safety from unseating of the tire (the tire pressure causes expanding of wired-on tires) and is preferably larger than 1.5 or 2 mm.
The rim well depth (Felgenbetttiefe; FBT) is preferably configured according to the ETRTO guidelines for ease of tire change and is preferably larger than 2 mm.
The radially deepest point of the rim well is provided in the rim well trough. Preferably in the axial rim center, may be outside of the center in the case of asymmetric rims.
The radius at the rim flange (R) is preferably configured according to the ETRTO guidelines regarding safety from unseating of the tire and is preferably (approximately) 0.8 mm.

On the whole, the invention provides for an advantageous bicycle and advantageous wheel components which enable a reliable operation.

Further advantages and features of the present invention can be taken from the exemplary embodiments which will be discussed below with reference to the enclosed figures.

### BRIEF DESCRIPTION OF THE DRAWINGS

The figures show in:

FIG. 1 a schematic illustration of a mountain bike;

FIG. 2 a schematic illustration of a racing bicycle;

FIG. 3 an enlarged detail of a side view of a bicycle according to the invention with a mid-mounted motor;

FIG. 4 a schematic side view of a wheel of one of the bicycles in FIG. 1 or 2;

FIG. 5 a schematic cross section of a rim and a tire of a bicycle according to the invention;

FIGS. 6a, 6b a schematic illustration of a magnetic device for a bicycle according to the invention; and

FIG. 7 schematic cross sections of rims with magnetic devices.

### DETAILED DESCRIPTION

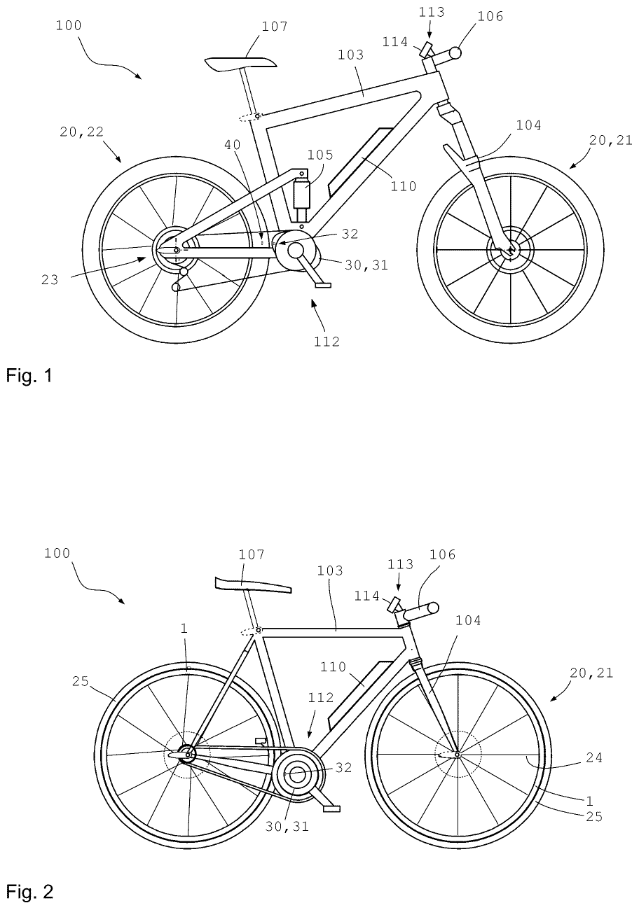

The FIGS. 1 and 2 each show a mountain bike respectively racing bicycle 100 according to the invention. The mountain bike respectively racing bicycle 100 are each provided with two wheels 20, a front wheel 21 and a rear wheel 22.

The two bicycles 100 are each provided with a frame 103, a bicycle fork 104, a handlebar 106 and a saddle 107. The handlebars 106 may each accommodate a bicycle computer as a control device 113 with a display 114.

Both of the wheels 20 each comprise a hub 23 and spokes 24 and a rim 1, on which a tire 25 is accommodated.

Furthermore, both of the bicycles 100 are provided with an electric motor 30 as an auxiliary motor, which provides assistance. The electric motors 30 are each configured as a mid-mounted motor 31 and are received on the pedal drive 112 respectively the pedal drive 112 is received on the electric motor. A storage battery 110, shown simplistically on the frame 103, may likewise for example be incorporated in the down tube or in another spot, and may thus be invisible in normal operation.

A sensor 32 is schematically shown on the mountain bike 101, which captures the pulses of the magnetic device 40 as it rotates past. The control device 113 employs the signals for controlling the electric motor 30. Moreover, the signals may be evaluated and may for example indicate irregularities of the wheel such as a radial run-out or a side run-out.

The bicycles 100 receive the magnetic device radially outwardly on the rim well inside of a volume which is enclosed by the rim body (on the whole) and the tire. Thus, the magnetic device 40 is not visible in normal operation. Furthermore, the magnetic device 40 is protected and securely accommodated.

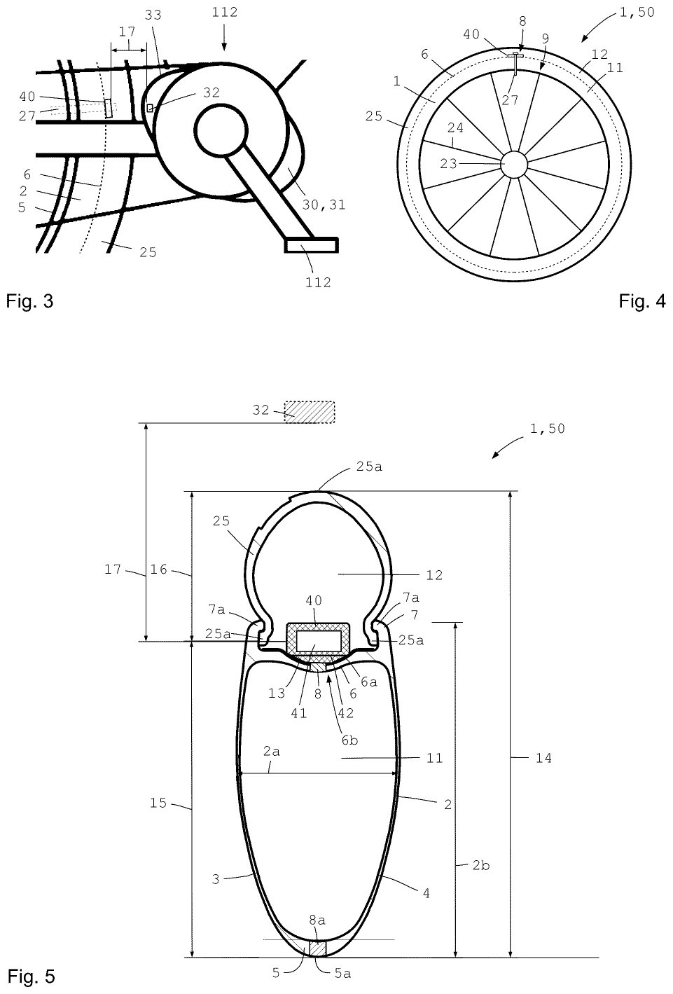

FIG. 3 shows a schematic side view of a bicycle 100 according to the invention, for example the bicycle in FIG. 1 or FIG. 2, where a mid-mounted motor 31 is provided as an electric motor 30 for riding assistance. A crank drive with pedals respectively a pedal drive 112 serves for pedalling.

The rim 1 is schematically shown with the rim body 2 and the tire 25 mounted thereon. The magnetic device 40 accommodated on the rim well 6 of the rim body 2 is drawn in broken lines.

Also drawn is, what is presently the minimum distance 17 between the sensor 32 disposed in the housing 33 of the electric motor 30, and the magnetic device 40. Due to the fact of this distance 17 being very small, the magnetic field strength of the magnetic device 40 can be captured even more reliably. Moreover, the magnetic field strength can be reduced.

Furthermore, the small distance 17 results in more reliable and better reproducible capturing of the signals from the magnetic device 40 due to the sensor 32 in the housing 33 of the electric motor 30 or in its vicinity. At any rate, the configuration shown does not require any external cables or only short and preferably no cable connections between the sensor 32 and the electric motor 30.

The signal of the sensor 32 can be transmitted from the electric motor 30 via the existing connections (wireless or wire-bound) to the control device 113, where the signals are evaluated.

FIG. 4 shows a simplistic side view of a wheel component 50 with a rim 1 and a tire 25 mounted on the rim 1. One can clearly recognize the spokes 24, the schematically shown hub 23, and the magnetic device 40 accommodated in the interior of the rim body and the tire, and fastened on the rim well 6.

FIG. 5 shows a simplistic cross section of an aerodynamic rim 1 with an aerodynamic tire 25 mounted thereon, and a schematically drawn sensor 32. The rim 1 has a rim body 2. The rim body 2 has two rim flanks 3, 4, presently together forming the rim base 5 in a central region. The rim 1 is configured as a hollow rim. The rim flanks are interconnected by a rim well 6. The rim flanks extend radially further outwardly beyond the rim well, where they form rim flanges 7 with beads 7a protruding inwardly. The beads 7a secure the beads 25 of the tire 25.

The rim body 2 together with the tire 25 encloses a tire cavity 12. The magnetic device 40 is accommodated and fastened on the rim well 6 in the rim well area 6a. As the wheel 20 rotates, the magnetic device 40 generates signals which the sensor 32 can detect, which enable to capture and control the travelling parameters and the electric motor 30.

The magnetic device 40 is shown as attached on a rim tape 13 on the rim well 6. The rim well 6 is not tight due to the spoke holes 9 and is covered by a rim tape 13 (in air-tight systems, without a separate tube).

The radial height 14 from the inner peripheral surface 5a of the rim base 5 to the tread 26 of the tire 25 is more than twice the radial height 16 from the magnetic device 40 to the outwardly peripheral surface 26, i.e. to the tread 25a of the tire 25. The inner peripheral surface of the rim body 2 forms the rim base area 5a. Here, the rim base area 5a is provided by the rim base 5. If no hollow space is provided, then the radially outwardly area of the rim body 2 forms the rim well area 6a, and the radially inwardly area forms the rim base area 5a.

The radial height 15 shown, from the inner peripheral surface 5a of the rim base to the (central) radial position of the magnetic device 40 is larger than the radial height of the distance from the magnetic device 40 to the tread 25a of the tire 25. In the example shown, the radial height 15 is again larger or of a similar size as is the radial distance from the magnetic device 17 to the sensor 32.

The schematic illustration of FIG. 5 clearly shows that in these rims and wheel components 50, the radial distance 17 from the magnetic device 40 to a sensor 32 on the frame or inside of the mid-mounted motor 31, can be noticeably reduced. Thus, the security of generating and transmitting the pulses and the reliability of the system on the whole can be increased. Moreover, the magnetic device is fastened on the rim well 6, secure against loss and protected, and causing the least interference possible.

In FIG. 5 one can see that the (aerodynamic) rim body 2 has an axial width 2a that is less than the radial height 2b of the rim body 2. Also, the axial width 2a is less than the radial distance from the rim base to the rim well.

The radial distance from the magnetic device to the sensor 32 is preferably less than three times or twice the radial height 2b of the rim body 2. In other configurations, other ratios are possible.

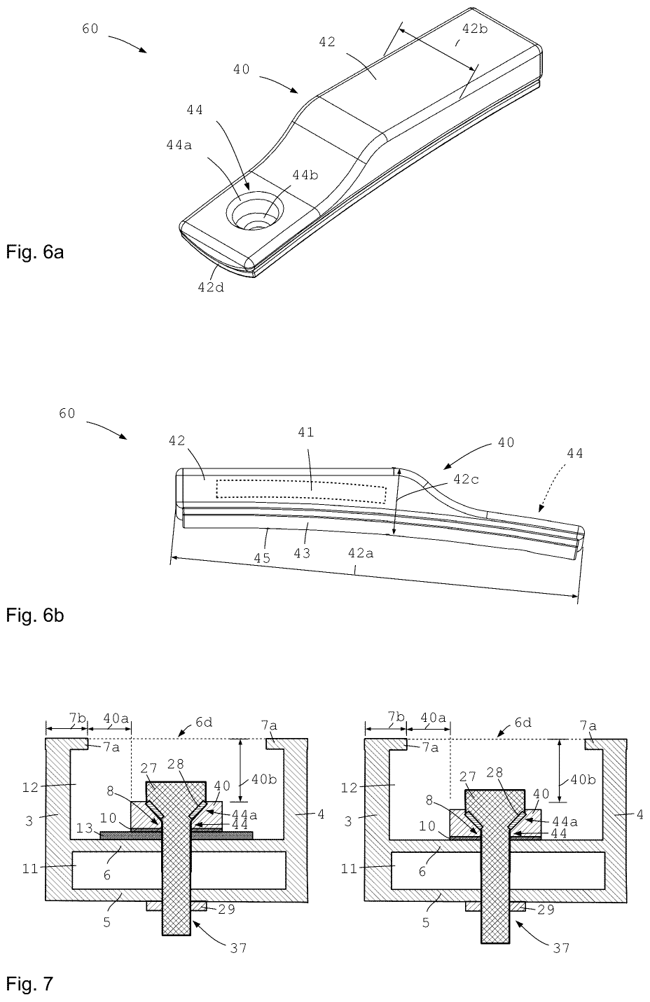

FIGS. 6a and 6b show a concrete configuration of a wheel component 60 with a magnetic device 40, which is adapted to the configuration of the rim well 6 along, and transverse to, its longitudinal direction. In the housing 42 of the magnetic device 40, a mounting hole respectively a fastener accommodation 44 (which need not be circumferentially closed) is configured, through which the valve 27 of a bicycle tube or a “tubeless” valve 27 can be passed. This is another safety device for the magnetic device 40.

The adapted cross section 42d of the bottom is recognizable. The housing shown has an axial width 42b, a length 42a in the peripheral direction, and a height 42c. The dimensions are provided such that the magnetic device 40 is accommodated on the rim well area 6a of the rim well 6 so that the magnetic device 40 does not (largely) impede mounting and demounting a tire 25 and does not radially protrude beyond the rim flanges 7.

The interior of the housing 42 can accommodate and protect a magnet 41 (or a number of magnets 41).

FIG. 7 shows on the left and right, schematic cross sections of a rim 1 as the wheel component 50, and mounted thereon, a magnetic device 40 as the wheel component 60. The rims 1 are each configured as a hollow space rim, comprising a rim body 2, a rim base 5 and a rim well 6, between which the hollow space 11 is configured. The rim flanks 3, 4 form, at the radially outwardly end, beads 7a on the rim flanges 7. The beads 7a accommodate and secure a tire. This is where the tire cavity 12 is located after mounting a tire.

The rim flanges 7 and the rim well 6 open up a rim well space 6d. In FIG. 7, the radially outwardly boundary of the space 6d is enclosed by the broken line connecting the two rim flanges 7. In all the configurations, this circumferential and (approximately) hollow cylindrical space 6d preferably accommodates the entire magnetic device. In particular, in the case of aerodynamic rim bodies having a high structure, whose hollow space is radially clearly higher than the area of the rim flanges (see e.g. FIG. 5), this achieves a short distance from the magnetic device 40 to a sensor 32 e.g. incorporated in the mid-mounted motor.

In the exemplary embodiment according to the image on the left in FIG. 7, a rim tape 13 is mounted and presently glued on, radially outwardly on the rim well, covering the spoke holes, not shown, and at least in the case of “tubeless systems” also sealing them radially inwardly to be airtight. The magnetic device 40 is also glued onto the rim tape 13 in the valve hole 8. For securing, a (double-sided) adhesive tape 42f having an adhesive layer 10 respectively two adhesive layers 10 is preferably used. The at least one adhesive layer 10 adheres for one, to the bottom of the magnetic device 40 and for another, to the rim tape 13, thus sealing the valve hole 8 in the rim well 6, so as to prohibit the escaping of air.

FIG. 7 shows on the right a variant, wherein no rim tape 13 is provided, and the housing (42) is directly and/or immediately glued (full-surface) onto the rim well 6 by means of the adhesive layer 10. This variant is feasible e.g. with tubeless systems.

On the whole, the FIGS. 1 to 7 show a bicycle 100 and the wheel components 50 provided therefor. The wheel component 50 comprises a rim 1 accommodating (or provided for accommodating) a tire 25, and a tire tread 25a, and a magnetic device 40 with a housing 42 and a magnet 41. The rim 1 comprises a rim body 2 with a peripheral rim well 6 and lateral rim flanks 3, 4, which form rim flanges 7 at the radially outwardly ends. A tire cavity 12 is defined between the rim well and the tire tread 25a. The housing 42 of the magnetic device 40 is fastened radially outwardly on the rim well of the rim body 2 and thus inside of the tire cavity.

In the peripheral direction, the bottom of the housing 42 shown has a (circumferential) cross section 42e adapted to the circumference of the rim well 6. In the axial direction, the bottom of the housing 42 also has a cross section 42d adapted to the cross section of the rim well 6. This means that the cross section of the bottom 42b of the housing 42 is adapted to the cross section of the rim body 2 in two directions, in the peripheral direction and in the axial direction. This enables good and secure seating. Furthermore, there is the lowest possible interference with the mounting and operation.

In the attachment range of the magnetic device, the housing 42 has a mounting hole 44, presently accommodating, and guiding through the valve hole 8 in the rim body 2, the valve 27. A seating 44a is configured on the housing 42 respectively the mounting hole 44, which is preferably adapted to the cross section of the valve.

In all the configurations and embodiments it is preferred for the shapes of the safety device 37 respectively the valve 27 and the mounting hole 44 to match one another so as to enable safe and reliable sealing even in the case of high operating pressures. Additionally, a sealing unit is preferably accommodated on the valve 27 and/or the mounting hole 44, as a sealant 28, to provide airtight seating including under operating pressure. The sealant may be configured as an e.g. annular seal such as an O ring or the like. Such an O ring may bear against a shoulder 44b (see FIG. 6a) in the mounting hole 44, sealing the area between the valve 27 and the shoulder 44b in the magnetic device 40.

The valve 27 may be part of a tube, or may be configured as a separate “tubeless valve”. The valve 27 is screw-connected with the rim base 5 by means of a valve nut 29.

The magnetic device 40 shown is accommodated radially outwardly on the rim well 6, and between the rim well and the radially outwardly end regions of the rim flanges 7, and axially between the rim flanges 7, and spaced apart from the rim flanges 7. The axial distances 40a of the magnetic device 40 from the two beads 7a are each larger than the thinnest wall thickness of the rim flanges 7, and as shown, also larger than the (largest) axial wall thickness 7b of the rim flanges 7 in the region of the beads 7a. The axial distance 40a is, in particular, larger than the axial thickness of the tire beads. Particularly preferably, the radial distance 40b of the magnetic device 40 from the radially outwardly end regions of the rim flanges 7 is larger than 1 mm or at least 0.5 mm or at least 0.25 mm.

While a particular embodiment of the present bicycle, and wheel component for a bicycle have been described herein, it will be appreciated by those skilled in the art that changes and modifications may be made thereto without departing from the invention in its broader aspects and as set forth in the following claims.

List of reference numerals:

| | |
|---|---|
| 1 | rim |
| 2 | rim body |
| 2a | axial width |
| 2b | radial height |
| 3 | rim flank |
| 4 | rim flank |
| 5 | rim base |
| 5a | rim base area |
| 6 | rim well |
| 6a | rim well area |
| 6b | rim well trough |
| 6d | rim well space |
| 7 | rim flange |
| 7a | bead |
| 7b | axial thickness |
| 8 | valve hole |
| 8a | valve hole in 5 |
| 9 | spoke hole |
| 10 | adhesive layer |
| 11 | hollow space |
| 12 | tire cavity |
| 13 | rim tape |
| 14 | height of 10 |
| 15 | height 5/40 |
| 16 | height 40/25 |
| 17 | distance 32/40 |
| 20 | wheel |
| 21 | front wheel |
| 22 | rear wheel |
| 23 | hub |
| 24 | spoke |
| 25 | tire |
| 25a | tire bead |
| 26 | tread |
| 27 | valve |
| 30 | electric motor |
| 31 | mid-mounted motor |
| 32 | sensor |
| 33 | motor housing of 30 |
| 37 | safety device |
| 40 | magnetic device |
| 40a | axial distance |
| 40b | radial distance |
| 41 | magnet |
| 42 | housing |
| 42a | length |
| 42b | width |
| 42c | height |
| 42d | cross section |
| 42e | cross section |
| 43 | fastener |
| 44 | through opening, mounting hole |
| 44a | seating |
| 44b | shoulder |
| 45 | bottom surface |
| 50 | wheel component |
| 60 | wheel component |
| 100 | bicycle |
| 103 | frame |
| 104 | fork, suspension fork |
| 105 | rear wheel damper |
| 106 | handlebar, handle |
| 107 | saddle |
| 110 | storage battery |
| 111 | sprocket assembly |
| 112 | pedal drive |
| 113 | control device |
| 114 | display |

1. A wheel component for at least partially muscle-powered vehicles and in particular bicycles,
comprising: a rim for accommodating a tire provided with a tire tread;
and comprising a magnetic device with a housing and a magnet;
wherein the rim comprises a rim body with a circumferential rim well and lateral rim flanks, which form rim flanges at the radially outwardly ends;
wherein the rim body comprises a valve hole in a radially outwardly rim well area;
and wherein a tire cavity is defined between the rim well and the tire tread of a tire provided to be accommodated on the rim body;
the housing of the magnetic device is connected with the rim body, secure against loss, by an adhesive layer between the rim well and the housing of the magnetic device;
and in the region of the valve hole, the housing of the magnetic device has a through opening for the valve, through which the valve protrudes, and fastens the magnetic device radially outwardly on the rim well of the rim body and thus inside of the tire cavity.

2. The wheel component according to claim 1, wherein the housing of the magnetic device is retained on the rim body, secure against loss, by an adhesive layer between the rim well and the housing of the magnetic device.

3. The wheel component according to claim 2, wherein the adhesive layer is disposed directly between the housing of the magnetic device and the rim well.

4. The wheel component according to claim 2, wherein between the housing of the magnetic device and the rim well, a circumferential rim tape is disposed, and wherein the adhesive layer is disposed directly between the housing of the magnetic device and the rim tape.

5. The wheel component according to claim 1, wherein a hollow space is configured in the rim body, wherein the hollow space is radially inwardly enclosed by the rim base and radially outwardly, by the rim well.

6. The wheel component according to claim 1, wherein the bottom surface of the housing of the magnetic device is configured curved in the peripheral direction of the rim.

7. The wheel component according to claim 1, wherein the bottom surface of the housing of the magnetic device is adapted to the cross sectional profile of the rim well area.

8. The wheel component according to claim 1, wherein a circumferential rim well trough is configured on the rim well, in which the magnetic device is accommodated.

9. The wheel component according to claim 1, wherein the lateral distance of the rim flange from the magnetic device is larger than the axial wall thickness of the rim flange.

10. The wheel component according to claim 1, wherein an adhesive tape is attached to the bottom surface of the housing, which connects the magnetic device with the rim body, wherein the adhesive tape is glued onto one of the rim tape and the rim body.

11. The wheel component according to claim 1, wherein radially outwardly end regions of the rim flanges form axially inwardly protruding, circumferential beads,
and wherein a tire is accommodated on the rim flanges, and wherein tire beads of the tire bear axially inwardly against the axially inwardly protruding, circumferential beads of the rim flanges,
and wherein the magnetic device is accommodated axially between the circumferential beads.

12. The wheel component according to claim 1, wherein the magnetic device is accommodated radially between the rim well and the radially outwardly end regions of the rim flanges, and axially between and spaced apart from, the rim flanges.

13. The wheel component according to claim 12, wherein the axial distances of the magnetic device from the two beads are each larger than the thinnest wall thickness of the rim flanges.

14. The wheel component according to claim 1, wherein the radial distance of the magnetic device from the radially outwardly end regions of the rim flanges is larger than 0.25 mm.

15. The wheel component according to claim 1, wherein the rim body has an axial width that is less than the radial height of the rim body.

16. The wheel component according to claim 1, wherein the magnetic device comprises a seating for sealing the valve at the mounting hole, and wherein a sealant is accommodated on the seating.

17. A bicycle comprising: at least two wheels and an at least partially muscle-powered pedal drive; wherein at least one of the wheels comprises a wheel component according to claim 1;
wherein at least one of the wheels is configured as a front wheel and at least one of the wheels, as a rear wheel, each comprising a hub and connected with the hub; a rim with a rim body with lateral rim flanks, which form rim flanges at the radially outwardly ends; wherein the rim body comprises between the rim flanges, a rim well with a radially outwardly rim well area on which a valve hole is configured; and a tire with a tire tread mounted on the rim body; wherein the tire tread and the rim well define a tire cavity;
wherein at least one wheel accommodates a magnetic device on the rim well inside of the tire cavity, for generating pulses on a sensor as the wheel rotates.

18. The bicycle according to claim 17, wherein at least one sensor is comprised for obtaining at least one travelling parameter, capturing magnetic pulses from the rotary motion of the wheel.

19. The bicycle according to claim 18, wherein at least one sensor is disposed on the frame and in particular in the region of the bottom bracket or on the seat tube.

20. The bicycle according to claim 17, wherein an electric motor for assisting the pedal drive is comprised, wherein the electric motor is configured as a mid-mounted motor and is accommodated in the longitudinal direction between the front wheel and the rear wheel, and wherein a sensor is accommodated in the housing of the electric motor for obtaining at least one travelling parameter.
